(19) United States
(12) Patent Application Publication
(10) Pub. No.: US 2009/0309050 A1
(43) Pub. Date: Dec. 17, 2009

(54) ELECTROPNEUMATIC VALVE

(75) Inventor: Frank MARKS, Dusseldorf (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/483,083

(22) Filed: Jun. 11, 2009

(30) Foreign Application Priority Data
Jun. 12, 2008 (DE) 10 2008 028 189.1

(51) Int. Cl. F16K 31/02

(52) U.S. Cl. 251/14

(57) ABSTRACT

An electropneumatic valve is disclosed for driving a pneumatic actuator drive to activate fittings in automation systems. The valve can have at least one electropneumatic transducer and a pneumatic booster, which has at least one valve device for optionally connecting a connecting duct, which can be connected to the actuator drive, to at least one of an air inflow duct and an air outflow duct. The at least one valve device can be activated as a function of an electrical actuation signal by the electropneumatic transducer. According to an exemplary configuration, at least one flow sensor whose output signal is fed back to the electrical actuation signal can be arranged in the conducting duct which is connected to the actuator drive.

### RELATED APPLICATION

This application claims priority under 35 U.S.C. §119 to German Patent Application No. 10 2008 028 189.1 filed in Germany on Jun. 12, 2008, the entire content of which is hereby incorporated by reference in its entirety.

### FIELD

The present disclosure relates to an electropneumatic valve for driving pneumatic actuator drives to activate fittings in automation systems.

### BACKGROUND INFORMATION

Electropneumatic valves are used to drive and control the position of actuator drives or control drives, including both single-acting and double-acting designs, as well as for blocking and venting designs.

Valves of this type are known in principle. See, for example, EP 1758 007 A1. According to this document, the valve is composed of at least a control pressure regulator, a pneumatic booster, an electropneumatic transducer, an air inflow duct, an air outflow duct, and a connecting duct which connects to the actuator drive.

A pneumatic booster is understood within the scope of this description to be a technical device which controls a pneumatic output signal using a pneumatic input signal.

The electropneumatic transducer can be supplied with an operating medium from the air inflow duct. This operating medium is typically a compressed gas, but any other fluid medium can be utilized. The operating medium which is fed to the electropneumatic transducer usually has a pneumatic pressure which is required to position the drive. In order to perform internal control of the pneumatic booster, a significantly lower control pressure of the same operating medium, which is as constant as possible, is extracted from the air inflow duct. For this purpose, the operating medium is fed to a control pressure regulator which reduces the pressure of the operating medium to the desired control pressure and regulates it to a constant value. The pneumatic booster is controlled with the operating medium which is reduced to the control pressure. Possible impurities are kept away from the pneumatic system by means of filters.

The electropneumatic valve is activated by feeding in electrical energy after the electropneumatic valve has been supplied with the operating medium as a pneumatic energy carrier. For this purpose, the electropneumatic valve is equipped with an electropneumatic transducer, which is driven electrically and manipulates the control pressure to perform pneumatic driving of the pneumatic booster.

The electropneumatic transducer is a converter which, on the basis of an electrical input signal, influences the control pressure circuit of the pneumatic booster in a selective fashion. By means of this electropneumatic transducer it is possible to control the pneumatic booster in such a way that, in a first operating mode, the operating medium is fed in a selective fashion from the air inflow duct into the connecting duct which connects to the pneumatic actuator drive, or, in a second operating mode, the operating medium is fed in a selective fashion from the pneumatic actuator drive into the atmosphere via the air outflow duct, or, in a third operating mode, the operating medium is enclosed in a selective fashion in the actuator drive to maintain the instantaneous position of the actuator drive. For this purpose, the pneumatic booster has a first pneumatic valve for connecting the air inflow duct to the connecting duct which connects to the actuator drive, and a second pneumatic valve for connecting the air outflow duct to the connecting duct which connects to the actuator drive. Such an arrangement is referred to according to the standards as a 3/3 way valve with a blocking center position.

EP 1758 007 A1 also discloses equipping the electropneumatic transducer with piezoelectric bender actuators which can be driven with a small amount of electrical energy. The low energy demand is a core requirement for use in two-conductor devices in automation equipment which draw their energy from a 4.20 mA current loop via their driving signal.

A transmission characteristic curve can describe the assignment of the electrical input signal in an electrical unit at the electropneumatic transducer to the output signal at the connecting duct which connects to the actuator drive as a set opening cross section or as a through-flow unit. The transmission characteristic curve can be defined by three characteristic ranges which, starting from the venting range, extends via the sealing-tight range to the ventilation range.

The sealing-tight range describes the range of electrical driving in which the electropneumatic valve seals tight the side located on the connecting duct which connects to the actuator drive with respect to all possible ventilation and venting paths. In the ventilation range, the output of air through the connecting duct which connects to the actuator drive is essentially proportional to the electrical driving signal with a constant gradient up to the full air output signal. In the venting range, the air output signal at the air outflow side follows the electrical driving signal essentially proportionally, with a constant gradient up to the full air outflow rate.

The transition from the sealing-tight range into the venting range is the opening point for venting, and the transition from the sealing-tight range into the ventilation range is the opening point for ventilation. The opening points for ventilation and venting are highly significant for the use of the electropneumatic valve in an electropneumatic position regulator for high regulating quality with respect to the connected actuator drive.

A high regulating quality is impeded in an electropneumatic valve of this type by the hysteresis between the forward characteristic curve and return characteristic curve and the drift of the opening points. In the case of electropneumatic transducers with piezo technology, these effects are due in particular to the piezo ceramic and are dependent on ambient influences such as the temperature of the piezo ceramic and/or moisture/soiling on its surface and resulting leakage currents. In particular, valves with piezo bender actuators can be provided with a corresponding surface. These effects occur in a similar form with magneto-inductive driving means.

However, other influences such as extension of the length of the materials used, friction in the overall structure and adjustment devices, and the mechanical setting behavior of the electropneumatic transducer, which can be caused, in particular, by temperature cycles over the permissible temperature range, also cause these effects.

Since the opening points drift over such influencing variables, an opening point cannot be reliably assigned to a previously determined electrical actuation variable for the pilot control valve. Alternatively, a through-flow quantity at the output which is sufficiently small for a regulating process cannot be reliably assigned to a constant value which is applicable at any time and has been determined by calibration when the system was activated.

The compensation of hysteresis can also be significant for the regulating quality. Since there is an offset between a forward characteristic curve and a return characteristic curve, the pneumatic booster does not follow the electrical actuation variable directly. Since the magnitude of the hysteresis is also subject to such ambient influences, it is not known, at the operating time, how much the actuation variable has to be changed in order to control the opening cross section or the quantity of air in the pneumatic booster with the desired order of magnitude in the opposite direction.

### SUMMARY

An exemplary electropneumatic valve is disclosed herein for driving a pneumatic actuator drive. The electropneumatic valve can have at least one electropneumatic transducer and at least one pneumatic booster, which has at least one valve device for optionally connecting a connecting duct, which can be connected to the actuator drive, to at least one of an air inflow duct and an air outflow duct. The at least one device can be activated by means of the electropneumatic transducer as a function of an electrical actuation signal. According to an exemplary embodiment, at least one flow sensor can be arranged in the connecting duct, which connects to the actuator drive, and the sensor can output a signal indicating a sensed variable as feedback to the electrical actuation signal.

### BRIEF DESCRIPTION OF THE DRAWINGS

Further advantages and details of the disclosure are explained in more detail below with reference to exemplary embodiments. In the drawings which are necessary for this:

FIG. 1 is a basic illustration of an exemplary electropneumatic valve,

FIG. 2 is a basic illustration of an exemplary characteristic curve of an electropneumatic valve, and

FIG. 3 is an exemplary illustration of a detail of an electropneumatic valve.

### DETAILED DESCRIPTION

According to an exemplary embodiment, an electropneumatic valve is provided which permits the quantity of air at the connecting duct, which can be connected to the actuator drive, to be set in accordance with the electrical actuation signal independently of drift and/or hysteresis.

Exemplary embodiments of the present disclosure are based on an electropneumatic valve for driving a pneumatic actuator drive. The exemplary electropneumatic valve can have at least one electropneumatic transducer and a pneumatic booster, which can have at least one valve device for optionally connecting the connecting duct, which can be connected to the actuator drive, to at least one of the air inflow duct and the air outflow duct. According to an exemplary configuration, the at least one valve device can be activated by the electropneumatic transducer as a function of an electrical actuation signal.

Exemplary embodiments of the present disclosure are also based on the realization that high regulating quality can be achieved in all areas of use of the respective end application, in particular in an electropneumatic position regulator, only if the desired cross sections of the valve and therefore the quantities of the operating medium can be set or metered reliably. Knowledge of the actual opening points facilitates this. The gradient of the characteristic curve can largely be unaffected in this context.

According to an exemplary embodiment of the present disclosure, at least one inflow sensor can be provided and arranged in the connecting duct which can be connected to the actuator drive. An output of the at least one inflow sensor can be feedback to the electrical actuation signal and/or to a signal processing device that generates the electrical activation device.

At the transition from a sealing-tight range into a venting range or into a ventilation range, that is to say at the opening points of the valve arrangement, the operating medium will flow in all cases through the connecting duct and can therefore generate a measurable effect at the flow sensor.

The actual opening point of the observed pneumatic valve can be advantageously sensed by means of the associated effect, namely the start of the through-flow. Furthermore, the degree of opening of the valve can be determined by means of the measurement of the quantity of the operating medium flowing therethrough. This makes it possible to reliably set small through-flow rates.

Acquiring the actual through-flow rate of the operating medium through the connecting duct allows both the influences of the drift of the opening point and the hysteresis on the setting of the quantity of air at the connecting duct, which connects to the actuator drive, to be eliminated.

According to an exemplary embodiment of the present disclosure, the through-flow sensor can be one or more thermal mass flow meters. Such mass flow meters are known. The measurement principle of thermal mass flow meters is based on the cooling of a heating element which is mounted on a holder when the heating element is dipped into a flowing fluid. The fluid flow which flows over the surface of the heating element takes up heat from it and as a result cools the heating element. The quantity of heat which the fluid flow picks up can depend on the temperature difference between the surface and the fluid as well as the flow itself. This can be described by a function

q=α(T_{O}−T_{F})

where
q: quantity of heat carried away
(T_{O}−T_{F}): temperature difference and
α: proportionality constant.

The proportionality constant α is directly dependent on the flow here and is a function of the mass flow density across the heating element α=ƒ(ρv)˜\sqrt{ρv}. If the temperature difference between the surface and the fluid and the heat output which is necessary to generate this temperature difference is known, the mass flow rate across the heating element can therefore be determined.

The sensing of the searched opening points advantageously remains free of reaction with respect to the observed pneumatic valve.

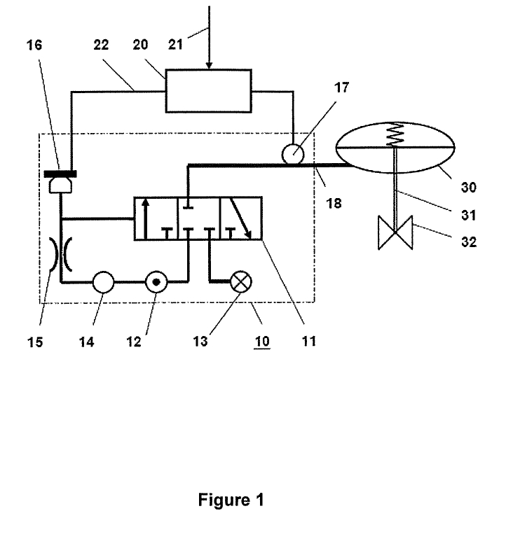

FIG. 1 illustrates an exemplary embodiment of an electropneumatic valve 10 for driving a single-acting pneumatic actuator drive 30 which has an electropneumatic transducer 16 and a pneumatic booster which has a valve device 11 for optionally connecting a connecting duct 18 which connects to the actuator drive 30 to an air inflow duct 12 or to an air outflow duct 13. The valve arrangement 11 can, for example, be embodied as a 3/3 way valve with a blocking center position, as illustrated in FIG. 1.

According to an exemplary embodiment, the 3/3 way valve with a blocking center position 11 can be configured to optionally connect the connecting duct 18, which can be connected to the actuator drive 30, to an air inflow duct 12 and/or an air outflow duct 13. The correct activation of the 3/3 way valve with a blocking center position 11 can be carried out by an electropneumatic transducer 16 as a function of an electrical actuation signal 22. For this purpose, the electropneumatic transducer 16 can be connected, via a pressure regulator 14 and a throttle device 15, to the air inflow duct 12, and can therefore be supplied with a low and constant pressure.

The actuator drive 30 can be connected via a lifting rod 31 to a fitting 32 which is suitable for controlling the flow of a process medium through a pipeline.

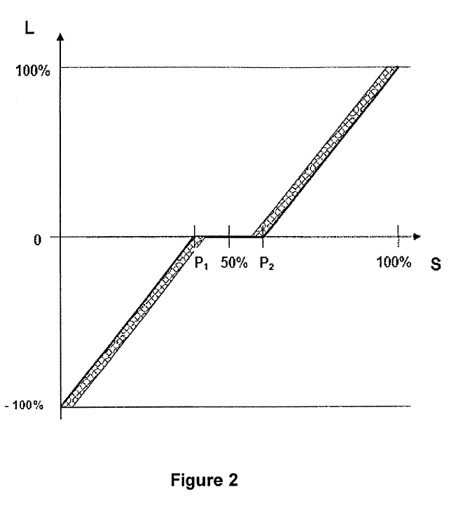

A signal processing device 20 can derive and/or generate the electrical actuation signal 22 for activating the electropneumatic transducer 16 from a received setpoint valve 21. In this context, as illustrated in the example of FIG. 2, the transmission characteristic curve of the electropneumatic valve 10, as illustrated in the example of FIG. 2, should be taken into account. The profile of the air flow L as a measure of the air through-flow rate per time unit in the direction of through-flow plotted against the control voltage S of the electrical actuation signal 22 exhibits three significant ranges.

In a first range, between 0% control voltage S and an opening point which is denoted by P₁, the air flow L is negative, which means that the actuator drive 30 is being vented. In this context, the 3/3 way valve with the blocking center position 11 can be set in such a way that the connecting duct 18, which can be connected to the actuator drive 30, is connected to the air outflow duct 13. Consequently, the air which is stored in the actuator drive 30 passes through the air outflow duct 13 into the surrounding environment.

In a subsequent second range of the control voltage S between the opening points P₁ and P₂, the air flow L is equal to zero, which means that the connecting duct 18, which connects to the actuator drive 30, is sealed tight with respect to all possible ventilation and venting paths. In this context, the 3/3 way valve with a blocking center position 11 is in its blocking center position. Consequently, the air is stored in the actuator drive 30. The sealing tight range can extend virtually symmetrically around approximately 50% of the control voltage S.

Finally, in a subsequent third range of the control voltage S between the opening point P₂ and 100% control voltage S, the airflow L is positive, which means that the actuator drive 30 is being ventilated. In this context, the 3/3 way valve with a blocking center position 11 can be set in such a way that the connecting duct 18, which connects to the actuator drive 30, is connected to the air inflow duct 12. Consequently, the actuator drive 30 is filled with air.

Furthermore, the behavior of the electropneumatic valve 10 can be subject to hysteresis. This means that a change in direction of the control voltage S can be transformed into an equivalent change in the air flow L only after a certain delay. This behavior, which is referred to as hysteresis, is illustrated in the example of FIG. 2 by hatched surfaces at the respective characteristic curve sections.

According to the exemplary embodiment illustrated in FIG. 1, a flow sensor 17 can be arranged in the connecting duct 18 which connects to the actuator drive 30. The flow sensor 17 can be located in the flow of the operating medium through the connecting duct 18 to the actuator drive 30, for example. The operating medium which flows in order to ventilate or vent the actuator drive 30 can flow through the connecting duct 18 as a function of the respective position of the 3/3 way valve with a blocking center position 11. The flow sensor 17 can therefore be arranged to sense quantity of the flow through the connecting duct 18, according to this embodiment.

According to an exemplary embodiment, the flow sensor 17 can be configured to sense the flow, as a variable, without sensing an item of directional information of the flow. The directional information of the flow can be dispensed with since it arises inevitably from the switched-off electrical actuation signal 22. If the operating medium flows through the connecting duct 18 for ventilating or venting the actuator drive 30, the operating state is certainly outside the range of sealing tight between the opening points P₁ and P₂ in the illustration in the example of FIG. 2.

The flow sensor 17 can be connected to the signal processing device 20 according to an exemplary embodiment illustrated in FIG. 1. The output signal of the flow sensor 17 can therefore be fed back to the electrical actuation signal 22 via the signal processing device 20. For this purpose, the output signal of the flow sensor 17 can be logically linked to the setpoint value 21. Accordingly, the sensor 17 can output a signal indicating a sensed variable in the connecting duct 18 and/or actuator drive 30, and provide the output signal to the signal processing device 20 as feedback for generating the electrical actuation signal 22 based on the setpoint valve 21 and the output signal from the sensor 17.

In an exemplary embodiment of the disclosure, the flow sensor 17 can be highly sensitive. Its measuring accuracy can, on the other hand, be insignificant. Consequently, very small movements of the operating medium can be detected, and the opening points P₁ and P₂ can therefore be reliably detected.

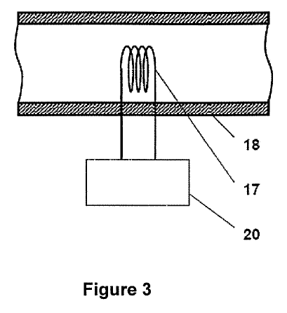

In an exemplary embodiment of the electropneumatic valve 10, the flow sensor 17 can be a thermal mass flow sensor. FIG. 3 illustrates an exemplary flow sensor 17 in a connecting duct 18 using identical reference symbols for identical means. The flow sensor 17 can be embodied as a thermal mass flow meter and can be connected to the signal processing device 20, as shown in the exemplary configuration illustrated in FIG. 3. The output signal of the thermal mass flow meter 17 can be fed back to the electrical actuation signal 22 using the signal processing device 20. This ensures that a change in the setpoint value 21 is directly converted into an adequate air flow L at the actuator drive 30.

According to an exemplary embodiment of the present disclosure, the flow sensor 17 can be accommodated in the housing of the electropneumatic valve 10. In another exemplary embodiment, the flow sensor 17 can be arranged in a connecting line, forming the connecting duct 18, between the electropneumatic valve 10 and the pneumatic actuator drive 30. According to this embodiment, retrofitting or equipping an existing device with an electropneumatic valve 10 and a pneumatic actuator drive 30 can be made easier.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Electropneumatic valve
11 Valve device
12 Air inflow duct
13 Air outflow duct
14 Pressure regulator
15 Throttle device
16 Electropneumatic transducer
17 Sensor
18 Connecting duct
20 Signal processing device
21 Setpoint value
22 Electrical actuation signal
30 Actuator drive
31 Lifting rod
32 Fitting
L Air flow
S Control voltage
P₁, P₂ Opening point

What is claimed is:

1. An electropneumatic valve for driving a pneumatic actuator drive, the electropneumatic drive having at least one electropneumatic transducer and at least one pneumatic booster, which has at least one valve device for optionally connecting a connecting duct, which is connectable to the actuator drive, to at least one of an air inflow duct and an air outflow duct, the electropneumatic transducer being configured to activate the at least one valve device as a function of an electrical actuation signal, wherein
the electropneumatic valve comprises at least one flow sensor arranged in the connecting duct which connects to the actuator drive, the at least one flow sensor being configured to output a sensed variable as feedback to the electrical actuation signal.

2. The electropneumatic valve as claimed in claim 1, wherein
the flow sensor is a thermal mass flow meter.
